(19) United States
(12) Patent Application Publication
(10) Pub. No.: US 2015/0021263 A1
(43) Pub. Date: Jan. 22, 2015

(54) Method and apparatus for extracting target molecules from a liquid by binding them to an activated polymer surface

(71) Applicant: Anna Madeleine Leone, Oakland, CA (US)

(72) Inventor: Anna Madeleine Leone, Oakland, CA (US)

(21) Appl. No.: 13/987,373

(22) Filed: Jul. 17, 2013

(51) Int. Cl. C08J 7/12; B01D 29/00

(52) U.S. Cl. CPC C08J 7/12; B01D 29/00
USPC 210/502.1; 525/464; 220/561

(57) ABSTRACT

An apparatus and method for producing the apparatus that is used to bind one or more different types of target molecules to a polymer surface that has been treated, and thereby activated, according to the method. A three or four step process to activate the surface is described. After activation, a fifth step immerses the activated surface into a liquid which binds a quantity of the target molecules to the polymer surface by chemical binding and/or by molecularly imprinted polymers and/or by modified carbon nanotubes. The method is used to convert an inert polymer surface into the activated surface. Either ion exchange binding (3 step process) or binding by the use of molecularly imprinted polymers and/or carbon nanotubes (four step process) or both are simultaneously used to provide the apparatus that is capable of binding and thereby extracting a quantity of the target molecules from the liquid.

This application is related to issued U.S. Pat. No. 6,322,834 that issued on Nov. 27, 2001 and issued Divisional U.S. Pat. No. 6,391,359 that issued on May 21, 2002, both by inventor Anna Madeleine Leone, of which an entire content of each patent is included herein by way of reference.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

1. Field of the Invention

The present invention, in general, relates to the removal of toxins from liquids and, more particularly, to a method and apparatus for extracting target molecules contained in a liquid and binding them to a polymer surface to reduce consumption of the target molecules.

There is a compelling need to remove toxins, as well as other target molecules, from liquids. As used herein, the terms “toxin” or “toxins” refer also to any desired “toxicant” or “toxicants”. Accordingly, the invention is capable of removing toxins (i.e., any poison that is produced by an organism) and/or toxicants (i.e., any type of a toxin or poison including those that are manmade).

As used herein, the term “liquid” includes any water-based solution or aqueous solution. As used herein, the term “liquid” is also intended to include Purées, mashes, and soups. Accordingly, as used herein the term “liquid” also includes sauces and puréed baby foods as well as any “water-based liquid” or “beverage”. Additional examples range from ordinary drinking water (bottled, well, or city water) and include all manner of beverages such as coffees, teas, milk including milks of all types and various fruit juices, including juices that contain a single type of fruit juice or a combination (i.e., blend) of different fruit juices, and including whether or not an additional sweetener has been added to the beverage. Mineral water and sodas and other sweetened drinks may also be treated to remove toxins using the apparatus and method as disclosed, herein.

As used herein, the term “target molecule(s)” includes all toxins, toxicants as well as other specific molecules that may not be known to be harmful or which are not harmful if consumed in limited quantities. The term “target molecule(s)”, as used herein, also includes molecules which may be harmful only to a limited segment of the population. For example, caffeine is a potential target molecule that is not harmful to most people, however, certain individuals for health reasons need to restrict their intake of caffeine. In summary, the term “target molecule” includes “all toxins, toxicants, toxic metals and toxic trace elements that have a unique geometric structure and/or molecular shape”.

The instant invention appertains to the removal of a quantity of any desired type or range of target molecules, as well as the removal of different types of target molecules. This is accomplished either by targeting for extraction only one type of molecule (in quantity) at a time by use of an apparatus produced by the method disclosed herein or by simultaneously targeting for extraction a plurality of different types of molecules.

Many of the target molecules intended for removal by use of the current invention are pesticides, insecticides and/or fungicides. Other target molecules are also possible, including any carcinogenic chemicals or substance. It is also desirable to remove harmful or toxic metals from liquids, such as mercury, lead and chromium 6.

As used herein, the terms “target” or “targets” include any desired target molecule(s) that are intended for removal (in any quantity) from a liquid.

A few of the more compelling examples of target molecules include arsenic 3, arsenic 5, endosulfan and thiabendazole. There is a significant need for their removal from fruit juices. Another especially compelling target molecule is caffeine.

Prior art decaffeination techniques are accomplished on a large scale and are referred to as “batch methods”. Every known batch method for decaffeination is not adaptable for small quantity decaffeination needs, such as for individual, at home use, when decaffeinating a single cup of coffee. Clearly, there is a tremendous need for a method and apparatus that would permit an individual to decaffeinate beverages one cup or one glass at a time in a short period of time during which time a sufficient quantity of caffeine molecules are extracted (i.e., removed) from the beverage. This would allow the individual to decaffeinate a preferred beverage when desired.

Additionally, prior art batch methods of decaffeination have numerous disadvantages. They have limited specificity in that significant quantities of molecules other than caffeine are also extracted by these methods. This, unfortunately, negatively affects the taste of the decaffeinated beverage.

Accordingly, there is also a need to decaffeinate a beverage that extracts a lesser amount of molecules other than caffeine from the beverage.

In general, it is most desirable that any process for extracting molecules from a liquid should extract a lesser amount of molecules other than the “targeted molecules”, whatever they may be, to prevent or minimize unintended or undesired changes or degradation from occurring to the liquid. An ability to extract fewer unwanted or “untargeted” molecules from a liquid as compared to the “targeted” molecules is referred to as specificity. An increase in specificity means that for any given quantity of target molecules that are extracted from the liquid, a lesser quantity of the “untargeted” molecules are also extracted. Therefore, high specificity is especially desirable.

There is a need to provide a process and apparatus that increases specificity when extracting targeted molecules from a liquid.

Other target molecules are possible and it is not possible to mention more than a sampling, herein. For example, Gamma-hydroxybutyrate (GHB—the date rape drug), is another possible target molecule.

Gamma-hydroxybutyrate (GHB) is a central nervous system depressant. First synthesized in the 1920s, it is a naturally occurring substance found in nearly all animal tissue, in some fruits, and in wine. It was used as a general anesthetic in the 1960s and 1970s.

It is marketed in some European countries as a liquid, or a light-colored powder that dissolves easily in liquid. It has no odor, tastes slightly salty, and is almost undetectable when mixed in a drink.

GHB is used recreationally to stimulate euphoria and hallucinations, to increase sociability, to promote libido and lower inhibitions. It is sold under names such as Liquid E and Liquid X.

GHB takes effect in about 15 to 30 minutes, and the effects last from three to six hours. They are similar to those of alcohol, and if alcohol and GHB are taken together the effects of each are intensified.

GHB is only detectable in urine for six to 12 hours after ingestion. The National Drug Intelligence Center (NDIC) says that in the United States GHB has surpassed Rohypnol as the substance most commonly used in date rapes, likely because GHB is much more easily available, cheaper and leaves the body more quickly.

Respiratory depression, coma, and death are possibilities when someone unknowingly takes a date rape drug, especially in large doses or in combination with alcohol. Short acting but potent benzodiazepines in particular can be extremely dangerous in combination with alcohol, potentially leading to extreme respiratory depression, a risk which is increased in someone who is naive to benzodiazepines. If the victim does not realize they have been drugged and continues to consume alcohol, the combined effects can lead to coma or death. Clearly, there is a need to prevent the unwanted consumption of GHB.

As of now, there is no practical way that a woman on a date who is given something to drink can ensure that she is not unwittingly also about to consume GHB. Ideally, if a simple spoon or stirring stick was carried in her purse that could extract this particular target molecule in quantity, before consuming any beverage she could simply use the device to stir the beverage while making conversation. This would be especially useful in preventing unwanted intercourse and in avoiding these health risks.

The term “coating” or “coatings” as used herein refers to a treatment process that is used to modify a surface of a polymer (plastic), changing it from an inert state to a state that can actively bind certain molecules or that can actively bind substances such as molecularly imprinted polymers or modified carbon nanotubes, thereto. Accordingly, the use of the terms “coating(s)” and “treatment(s)” refer to the same thing; modification of the surface of a polymer.

After treatment, the resulting polymer surface is said to be “activated” because of its transformation from an inert state (is unable to bind molecules or substances, thereto) to an “active” or “activated state” (in which it is capable of binding molecules or substances, thereto). Novel chemical modification of the polymer surface, as disclosed herein, is necessary to activate the polymer surface.

Regarding the need for the current invention, there is significant risk to human health all over the planet that is caused by the undesired and largely unknown consumption of manmade toxicants that are manufactured to satisfy a variety of agricultural and other purposes. Contamination of produce, fruits and the inadvertent contamination of aquifers by various toxicants are primary factors contributing to these types of risks. Similar need arises from the undesired and largely unknown consumption of environmentally derived toxins. Accordingly, there is a critical need to remove toxicants and toxins from all manner of food and drink that is consumed.

For example, recent testing by Consumer Reports has revealed levels of arsenic higher than the FDA level of concern in several commercial juice samples, and particularly in baby food products. The level of concern, as defined by the FDA, is 23 parts per billion (ppb) for baby food products. By way of comparison, the FDA level of concern for arsenic in drinking water is 10 ppb. For bottled water, it is even lower at 5 ppb. It is perplexing as to why the FDA would allow nearly five times the levels of arsenic for juices that babies consume in large quantities as compared to bottled water that is primarily consumed by adults.

However, the need to remove arsenic from any of these liquids is significant. Therefore, an apparatus and method that can lower the level of arsenic in a liquid is desirable. Ideally, an apparatus and method that can lower the level of arsenic to not exceed FDA levels of concern is especially important.

It is particularly concerning that the highest levels of arsenic were seen in baby foods where the dosage, given the low body mass, results in potentially the highest potential toxicity level. What parent wouldn't want a safe, simple, fast and effective way by which they could ensure that arsenic levels in the foods they are about to give their babies have been significantly lowered?

It is recommended by the FDA that “chronic exposure” to arsenic in children should be below 5 ppb. However, this appears to be an unachievable goal given the way apples, for example, are produced and the large quantity of juice that is consumed by children.

With regard to the production of juice, agricultural procedures vary widely from country to country. For example, though apple juice may be labeled as a US product, typically over 60 percent of the apples used to produce the juice is from China. Most apples (whether consumed as apples or used to make apple and other juices) are grown outside of the United States.

What is the net effect? Recent testing of US labeled juice has revealed levels of up to 60 ppb, or twelve times the maximum permitted dosage for bottled water. Certain baby products contained seven times the FDA limit set for bottled water. Over ten percent of the products tested by Consumer Reports had over 10 ppb of arsenic. One is given pause when reflecting that this level of arsenic would be illegal (for consumption by adults or by children) if the juice was sold as bottled water.

There are also other significant areas of concern. For example, Attention Deficit Hyperactivity Disorder syndrome (ADHD) has been linked to pesticide ingestion in several studies. Over one-half of the juices tested in one study contained significant levels of a known carcinogen, thiabendazole. It is also known to affect fetus development. In addition, 98 percent of peaches tested positive for this pesticide/fungicide.

The United States Department of Agriculture (USDA) tested apples in one study and found over 40 pesticides present. Some of the toxins found are as follows: 70 percent of the apples tested included acetamiprid. 31.5 percent included azinphos methyl. 11 percent included the insecticide carbaryl. 83 percent included the fungicide DPA. 26.6 percent include the insecticide imidacloprid. 19.4 percent included the insecticide phosmet. 15.3 percent contained tetrahydrophthalimide. 88 percent included the fungicide thiabendazole. Methyl parathion, chlorpyrifos and acephate were also detected.

Of especial concern, over 12 percent of the organic juice tested was shown to contain thiabendazole. Keeping in mind that organic juice should not contain fungicides, this is especially alarming.

Endosulfan became a highly controversial agrichemical due to its acute toxicity and the potential for bioaccumulation and its role as an endocrine disruptor. Accordingly, because of the threat to human health and the environment a global ban on the manufacture and use of endosulfan has been negotiated. While the ban took effect in mid-2012 certain uses have been exempted for five additional years. However, it is still used extensively in India and China and a few other countries.

As over 60 percent of the apples used in the United States are from China it is a virtual certainty that endosulfan will continue to be present in our fruit juice for a considerable period of time.

The crux of the problem is that it is all but impossible to eliminate these and other toxins from our food supply. Therefore, the FDA cannot solve the problem simply by legislating more appropriate limits for human (and baby, child) consumption. However well intended such limits may be, if they were somehow enforceable, would severely curtail the available juice supplies which would also not be an acceptable solution.

When the fact is that a percentage of “organic” juices contain fungicides, pesticides and insecticides one thing is for certain, and that is the FDA cannot eliminate their presence from foods that are supposed to be free of them. This type of finding degrades consumer confidence regarding the purity of organic foods. If toxins cannot be eliminated, what is the solution?

Clearly, a more pragmatic solution is required and that solution, if possible, would involve the extraction of toxins and other target molecules from liquids prior to their consumption.

To accomplish this there are significant technical challenges to overcome. The process must be safe, sufficiently selective in extracting the targeted molecules, inexpensive, effective, and require little time to accomplish. It is not desirable to require consumers to immerse some foreign chemical compound into their beverages as part of an extraction process as this type of a solution would create new exposure to toxicant/carcinogen concerns.

An ideal material to use would include plastics. For example, consumers are familiar with plastic utensils and stirring sticks. Accordingly, consumer acceptance would be high if a device and method for extracting toxins from a liquid included immersion of a plastic device, such as a spoon or stirring stick or other small plastic device, into the liquid and simply stirring the liquid for a period of time.

However this has not, heretobefore, been possible. Because plastics, by design, are non-reactive there must be a surface modification in order to actively bind anything to a plastic surface. For the purpose of illustration, polycarbonate is being used to illustrate the process, however, the invention is not limited to polycarbonate use. It is to be understood that other types of plastics can be similarly modified to bind target molecules, based on the teachings herein or by obvious modification, thereto, after first having had benefit of the teachings herein disclosed.

Similarly, it is to be understood that similar modifications and enhancements can and will be accomplished to the method over the course of time to increase the quantity or specificity of target molecules that are being removed from the beverage and/or to decrease the time required to do so, based on the teachings herein or by obvious modification, thereto, again after first having had benefit of the teachings herein disclosed.

While virtually any shape of plastic object can be treated and used to embody the invention, a plastic spoon is a preferred shape as it can readily be used to stir a liquid or to contain or transfer a substance, such as a small quantity of a liquid for tasting or to add sugar to the liquid, etc. Additionally, a spoon shape is well recognized and its use in stirring a liquid is obvious to the general population.

If preferred, a plastic stirring stick or a more complex shape is also possible. Other possible shapes may be used that increase the surface area of the device which, in turn, can be used to increase the efficacy or in decreasing the time required in removing a predetermined quantity of target molecules.

As mentioned above, the target molecules need not be limited to the extraction of fungicides, insecticides, pesticides or other toxins. The current invention can be modified to accomplish the removal of a quantity of any desired target molecule from a liquid or any combination of different target molecules simultaneously from the liquid.

For example, it is desirable to provide a method and apparatus that can be used to remove a quantity of arsenic molecules from a liquid. If the removal of arsenic is the only goal a plastic spoon, for example, that has been treated to target the removal of arsenic can be provided. Consumers who wanted to remove arsenic from their beverage prior to its consumption would first immerse the treated spoon in the beverage, stir the liquid for a predetermined period of time and remove the spoon.

Similarly, if it is desirable to remove only endosulfan, a treated spoon (or other shape) can be provided for this purpose. The same would be true for the removal of thiabendazole.

However, a more desirable solution would include treatment of the plastic spoon (or other shape) to simultaneously remove arsenic, endosulfan and thiabendazole. One or more different treatment methods could be employed to produce an apparatus that could simultaneously remove a quantity of target molecules of different substances. Such a spoon, if used to stir a beverage prior to consumption, would simultaneously remove quantities of these three different categories of toxins. This is especially desirable because a consumer would not know what toxins may be present in any particular juice or other beverage.

Additionally, a consumer may want to treat a beverage prior to consumption to simultaneously remove any of various toxins that may be present and they may also simultaneously want to decrease the caffeine level in the beverage. Alternately, they may only desire to decrease the caffeine level in the beverage. Ideally, a method and apparatus for specifically targeting caffeine molecules for removal or for simultaneously removing a plurality of toxins and caffeine would be especially useful and desirable.

Removing caffeine without also removing other organic flavor-enhancing molecules has long been a challenge.

Ideally, a stirring stick that could be immersed in a caffeinated beverage and simply stirred for a short period of time that could remove, with high specificity, a sufficient amount of caffeine molecules is desirable.

Even our drinking water itself is subject to treatment prior to consumption. Water filters are commonly used to remove certain undesirable substances from drinking water. However, water filters have well-known limitations in their abilities. Immersion of an object, such as a treated plastic spoon, into the water for stirring prior to consumption would provide a new approach to filtering water that overcomes many of the long-standing limitations of prior art types of water filters.

Similarly, the target molecules for removal from the beverage may include any toxic or unwanted metal or any other unwanted ingredient. Ideally, a method and device that can be quickly, effectively, and inexpensively used to remove target molecules of all kinds is especially desirable.

As disclosed herein, different processes for removing target molecules may be combined in any one plastic device, as desired. Chemical binding techniques, after first treating the plastic, may be combined with the use of molecularly imprinted polymers (MIPS) to bind and thereby remove a wide variety of targeted molecules simultaneously from any beverage. MIPS may provide greater specificity in removing (primarily) only the targeted molecules. Chemical binding may provide an especially low cost solution for removing a broader spectrum of toxins. Together, both can be used to enhance and increase the efficacy of either process and to provide an optimum consumer product.

Similarly, chemical binding techniques, after first treating the plastic, may be combined with the use of modified carbon nanotubes (MCN) to bind and thereby remove a wide variety of targeted molecules simultaneously from any beverage. MCN may provide greater specificity in removing (primarily) only the targeted molecules. Chemical binding and the use of MCN, together, can be used to enhance and increase the efficacy of either process and to provide an optimum consumer product.

If desired, chemical binding along with the use of MIPS and MCN, in any preferred combination, can be used to enhance and increase the efficacy of the removal of the target molecules and, thereby, provide an optimum consumer product.

This range of options is available only because the current invention teaches how to treat a surface of a polymer to provide an activated surface, wherein the activated surface is then able to chemically bind target molecules and/or MIPS and/or MCN to the treated (or activated) polymer surface.

A brief, but in no way limiting discussion about molecular imprinting and MIPS follows. Additional reference information about MIPS is also available in the two issued U.S. Pat. Nos. 6,322,834 and 6,391,359 that have been included herein, by way of reference.

Molecular imprinting is a method used to create “template-shaped cavities” in polymer surfaces with memory of the template molecules to be targeted (via molecular recognition). Each template-shaped cavity provides an active binding site that has a “unique geometric structure” that is specifically suitable for capture of a targeted molecule.

The targeted molecule that has a corresponding shape and size to the site is recognized by selectively binding to the site, while an incorrectly shaped “non-target” molecule that does not fit the binding site is not recognized nor bound. Selectively binding only the precisely targeted molecules amongst the many present is called “specificity”.

Molecular imprinting is imprinting on a plastic surface, an artificial tiny lock for a specific molecule. Each imprinted polymer site grabs and locks in-place the specific targeted molecule.

A brief, but in no way limiting discussion about modified carbon nanotubes (MCN) follows.

Carbon nanotubes are allotropes of carbon with a cylindrical nanostructure. Single-walled nanotubes have a diameter of about one nanometer, with a tube length that can be significantly longer. Nanotubes can also be multi-walled.

These cylindrical carbon molecules have unusual properties, which are valuable for nanotechnology and many fields of science and technology. Carbon nanotubes have applications as additives to various structural materials and in the case of this invention, to polymers.

Nanotubes are members of the fullerene structural family. Their name is derived from their long, hollow structure with the walls formed by one-atom-thick sheets of carbon.

These sheets are rolled at specific and discrete angles, and the combination of the rolling angle and radius decides the nanotube properties. Individual nanotubes naturally align themselves into “ropes” held together by van der Waals forces, or, pi-stacking. They can be modified to perform a virtually unlimited variety of tasks. Modification of the nanotube would typically involve oxidation or nitration, for example, of the surface of the tube to produce nanotubes with active groups on the surface. These groups are then used as ‘attachment points’ for attaching MIPS to the nanotubes or for attaching the nanotubes directly to an activated apparatus, such as a polymer spoon or stirring stick, which has been modified according to a described third step of the method of the invention.

Two modified types of apparatus (spoons, etc.) that also include modified carbon nanotubes (MCN) are, therefore, possible after the third step has been accomplished. It is important to note that, as described, herein, it is also possible to chemically bind target molecules to the apparatus after the third step has been accomplished, without attachment of modified carbon nanotubes (MCN) or MIPS to the apparatus. The first modified type of apparatus includes a polymer device with only modified carbon nanotubes (MCN) attached to its surface for a moderate specificity activated-MCN-apparatus. The second modified type of apparatus, which is preferred, includes a polymer device that includes a plurality of MIPs that are attached to the MCN that are, themselves, attached to the surface of the apparatus, to form a highly specific combined MCN-MIP modified apparatus (spoon).

There is also a need in many areas on the planet to provide purer, higher quality drinking water. Ideally, the method described herein could be applied to a polymer surface when the polymer surface includes an interior of a container. Accordingly, a treated plastic container such as a one-gallon jug or any other desired size of container could be used to remove a wide array of toxins from whatever liquid is placed inside the container. The size of the container could be barrel-size, if preferred.

Ideally, after use the container would be washed with an acidic solution, with a subsequent rinse for reuse of the container.

Therefore, aplastic “stirring stick” that embodies these teachings could be used to “treat” one cup at a time to decrease the quantity of any preferred number of toxins or specific target molecules that are initially present in a liquid. If desired, the stirring stick could be discarded after one use or, if preferred, possibly reused.

Additionally, these teachings could be applied in different ways to create other devices, such as a plastic container, that would automatically treat (i.e., remove at least some of the target molecules from) the liquid placed in the container.

Similarly, these teaching could be applied to treat sheets of polymer. The sheets could, in turn, be used to provide an inexpensive way to remove target molecules and, thereby, purify a liquid prior to consumption. The sheets could be placed inside any container containing the liquid for a predetermined period of time. As desired, the liquid or sheets could be stirred, shaken or otherwise agitated to accelerate the process and improve efficacy. In this manner, a solution intended to benefit individual users as well as those residing in under-developed countries could be provided.

With regard to the need to decaffeinate a beverage in small quantities, there is a further need to provide an apparatus that accomplishes the decaffeination in an especially convenient manner. In particular, there is a need for a polymer filter that could be manufactured inexpensively and which could be inserted (i.e., placed) into a home (or commercial) coffee maker prior to brewing when a quantity of “decaffeinated” coffee is desired.

Ideally, the filter would be able to contain a quantity of ground coffee therein and could be placed inside any preexisting coffee filter, filter holder, or cone. The filter would preferably include a plurality of fine openings through which hot water could pass after first mingling with the ground coffee. A surface of the filter and/or the openings could be treated to bind, and thereby remove, caffeine molecules as the hot water passed through the polymer filter. The filter could be used to replace existing paper filters or used in conjunction with them, as desired.

Accordingly, there exists today a need for a method and apparatus for extracting target molecules from a liquid by binding them to an activated polymer surface that helps to ameliorate the above-mentioned problems and difficulties as well as ameliorate those additional problems and difficulties as may be recited in the “OBJECTS AND SUMMARY OF THE INVENTION” or discussed elsewhere in the specification or which may otherwise exist or occur and that are not specifically mentioned herein.

As various embodiments of the instant invention help provide a more elegant solution to the various problems and difficulties as mentioned herein, or which may otherwise exist or occur and are not specifically mentioned herein, and by a showing that a similar benefit is not available by mere reliance upon the teachings of relevant prior art, the instant invention attests to its novelty. Therefore, by helping to provide a more elegant solution to various needs, some of which may be long-standing in nature, the instant invention further attests that the elements thereof, in combination as claimed, cannot be obvious in light of the teachings of the prior art to a person of ordinary skill and creativity.

Clearly, such an apparatus and method would be useful and desirable.

2. Description of Prior Art

The removal of toxins, toxic metals, and other substances are, in general, known. For example, water filters are used for this purpose. However, water filters are not practical for the removal of toxins prior to the consumption of a beverage, such as a coffee, tea, juice, milk or other type of beverage because of the time and cost involved and because of a lack of specificity.

While the structural arrangements of the above described devices may, at first appearance, have similarities with the present invention, they differ in material respects: These differences, which will be described in more detail hereinafter, are essential for the effective use of the invention and which admit of the advantages that are not available with the prior devices.

### OBJECTS AND SUMMARY OF THE INVENTION

It is an object of the present invention to provide a method and apparatus for extracting target molecules from a liquid by binding them to an activated polymer surface that is easy to use.

It is also an important object of the invention to provide a method and apparatus for extracting target molecules from a liquid by binding them to an activated polymer surface that is inserted in a liquid and used to remove a quantity of the target molecules.

Another object of the invention is to provide a method and apparatus for extracting target molecules from a liquid by binding them to an activated polymer surface that includes chemically treating the surface of the polymer.

Still another object of the invention is to provide a method and apparatus for extracting target molecules from a liquid by binding them to an activated polymer surface that includes chemically treating the surface of the polymer to react chemically with and thereby bind the target molecules to the surface of the polymer.

Still yet another object of the invention is to provide a method and apparatus for extracting target molecules from a liquid by binding them to an activated polymer surface that includes chemically treating the surface of the polymer to bind a quantity of molecularly imprinted polymer (MIPS) particles, thereto, and thereby bind the target molecules to the MIPS disposed proximate the surface of the polymer.

Yet another important object of the invention is to provide a method and apparatus for extracting target molecules from a liquid by binding them to an activated polymer surface that includes chemically treating the surface of the polymer to react chemically with and thereby bind the target molecules to the surface of the polymer and also chemically treating the surface of the polymer to bind a quantity of molecularly imprinted polymer (MIPS) segments, thereto, and thereby bind the target molecules to the MIPS disposed proximate the surface of the polymer.

Still yet another important object of the invention is to provide a method and apparatus for extracting target molecules from a liquid by binding them to an activated polymer surface that is able to remove a quantity of pesticide molecules.

A first continuing object of the invention is to provide a method and apparatus for extracting target molecules from a liquid by binding them to an activated polymer surface that is able to remove a quantity of insecticide molecules.

A second continuing object of the invention is to provide a method and apparatus for extracting target molecules from a liquid by binding them to an activated polymer surface that is able to remove a quantity of fungicide molecules.

A third continuing object of the invention is to provide a method and apparatus for extracting target molecules from a liquid by binding them to an activated polymer surface that is able to remove a quantity of toxin molecules.

A fourth continuing object of the invention is to provide a method and apparatus for extracting target molecules from a liquid by binding them to an activated polymer surface that includes any desired target molecule.

A fifth continuing object of the invention is to provide a method and apparatus for extracting target molecules from a liquid by binding them to an activated polymer surface that includes caffeine as one of the target molecules.

A sixth continuing object of the invention is to provide a method and apparatus for extracting target molecules from a liquid by binding them to an activated polymer surface that can remove a plurality of different types of target molecules simultaneously.

A seventh continuing object of the invention is to provide a method and apparatus for extracting target molecules from a liquid by binding them to an activated polymer surface that includes a plastic spoon, a plastic stirring stick, or other type of plastic object for insertion into a beverage or other water-based liquid.

An eighth continuing object of the invention is to provide a method and apparatus for extracting target molecules from a liquid by binding them to an activated polymer surface that produces a modified plastic device, and wherein the modified plastic device is inserted into a water-based liquid to bind, and thereby remove, a quantity of the target molecules from the liquid.

A ninth continuing object of the invention is to provide a method and apparatus for extracting target molecules from a liquid by binding them to an activated polymer surface that produces a modified plastic device, and wherein the modified plastic device is inserted into a water-based liquid to bind, and thereby remove, a quantity of the target molecules from the liquid, and whereby the efficacy of the process is improved by using the modified plastic device to stir the liquid for a period of time.

A tenth continuing object of the invention is to provide a method and apparatus for extracting target molecules from a liquid by binding them to an activated polymer surface that includes a decrease in the time required to remove a quantity of the target molecules or an increase in the number of target molecules that are removed by increasing the number of binding sites present on the polymer surface.

An eleventh continuing object of the invention is to provide a method and apparatus for extracting target molecules from a liquid by binding them to an activated polymer surface that includes a decrease in the time required to remove a quantity of the target molecules or an increase in the number of target molecules that are removed by chemical modification of the polymer surface sufficient to facilitate chemical binding of the target molecules to the activated polymer surface or by the use of molecularly imprinted polymers (MIPS), or by a combination of both in one consumer product.

A twelfth continuing object of the invention is to provide a method and apparatus for extracting target molecules from a liquid by binding them to an activated polymer surface that delivers the process by insertion of a modified polymer surface into a water-based liquid for a predetermined period of time.

A thirteenth continuing object of the invention is to provide a method and apparatus for extracting target molecules from a liquid by binding them to an activated polymer surface that includes a decrease in the time required to remove a quantity of the target molecules or an increase in the number of target molecules that are removed by chemical modification of the polymer surface sufficient to facilitate chemical binding of the target molecules to the activated polymer surface or by the use of modified carbon nanotubes (MCN), or by a combination of both in one consumer product.

A fourteenth continuing object of the invention is to provide a method and apparatus for extracting target molecules from a liquid by binding them to an activated polymer surface that can be used with any water-based liquid or any hot or cold beverage.

A fifteenth continuing object of the invention is to provide a method and apparatus for extracting target molecules from a liquid by binding them to an activated polymer surface that can be used to reduce a quantity of a toxin in a beverage an amount sufficient to permit the beverage to meet an FDA requirement regarding any desired toxin.

A sixteenth continuing object of the invention is to provide a method and apparatus for extracting target molecules from a liquid by binding them to an activated polymer surface that delivers the process by insertion of a modified polymer surface into a water-based liquid for a predetermined period of time and stirring the modified polymer surface that is disposed in the liquid for a portion of the predetermined period of time.

A seventeenth continuing object of the invention is to provide a method and apparatus for extracting target molecules from a liquid by binding them to an activated polymer surface that is able to secure a quantity of molecularly imprinted polymers (MIPS) to the polymer surface at a plurality of different elevations above the surface, thereby increasing an effective density of the MIPS for a given surface area.

An eighteenth continuing object of the invention is to provide a method and apparatus for extracting target molecules from a liquid by binding them to an activated polymer surface, wherein the polymer surface includes an interior of a container that is capable of holding the liquid.

A nineteenth continuing object of the invention is to provide a method and apparatus for extracting target molecules from a liquid by binding them to an activated polymer surface that, after insertion into the liquid, binds a quantity of the target molecules to the polymer surface and wherein, subsequent to a removal of the polymer surface from the liquid, a remaining quantity of the target molecules in the liquid is decreased.

A twentieth continuing object of the invention is to provide a method and apparatus for extracting target molecules from a liquid by binding them to an activated polymer surface that, after insertion into the liquid, binds a quantity of the target molecules to the polymer surface and wherein, subsequent to a removal of the polymer surface from the liquid, a remaining quantity of the target molecules in the liquid is decreased and wherein the polymer surface can be further treated to remove at least portion of the target molecules therefrom sufficient to permit reuse of the apparatus that includes the polymer surface.

A twenty-first continuing object of the invention is to provide a method and apparatus for extracting target molecules from a liquid by binding them to an activated polymer surface that, after insertion into the liquid, binds a quantity of the target molecules to the polymer surface and wherein, subsequent to a removal of the polymer surface from the liquid, a remaining quantity of the target molecules in the liquid is decreased and wherein the polymer surface can be further treated by exposure to a chemical or by washing to remove at least a portion of the target molecules therefrom sufficient to permit reuse of the apparatus that includes the polymer surface.

A twenty-second continuing object of the invention is to provide a method and apparatus for extracting target molecules from a liquid by binding them to a modified activated polymer surface that, after insertion into the liquid, binds a quantity of the target molecules to the modified polymer surface and wherein, subsequent to a removal of the modified polymer surface from the liquid, a remaining quantity of the target molecules in the liquid is decreased.

A twenty-third continuing object of the invention is to provide a method and apparatus for extracting target molecules from a liquid by binding them to a further modified activated polymer surface that, after insertion into the liquid, binds a quantity of caffeine molecules as the target molecules to the further modified polymer surface and wherein, subsequent to a removal of the further modified polymer surface from the liquid, a remaining quantity of caffeine molecules in the liquid is decreased.

A twenty-fourth continuing object of the invention is to provide a method and apparatus for extracting certain target molecules from a liquid by binding a portion to a modified activated polymer surface and by binding a remainder of target molecules to a further modified polymer surface that, after insertion into the liquid, binds a quantity of toxin, pesticide, fungicide or insecticide molecules to the modified polymer surface, and binds a quantity of caffeine molecules as the remainder of target molecules to the further modified polymer surface, and wherein, after insertion of the apparatus into the liquid for a predetermined period of time and wherein, subsequent to a removal of the apparatus from the liquid, a remaining quantity of the toxin, pesticide, fungicide or insecticide molecules in the liquid is decreased and a remaining quantity of caffeine molecules in the liquid is decreased.

A twenty-fifth continuing object of the invention is to provide a method and apparatus for extracting certain target molecules from a liquid and binding them to a modified activated polymer surface that includes a plastic object for immersion in a caffeinated beverage, such as a spoon or a stirring stick that is stirred for a short period of time and either removed or left in the caffeinated beverage which would remove a sufficiently large amount of caffeine molecules from the caffeinated beverage to produce a less-caffeinated beverage and, thereby, decrease the amount of caffeine consumed by a person who drank the less-caffeinated beverage.

A twenty-sixth continuing object of the invention is to provide a plastic device that, by immersion of a portion of the device that includes a chemically modified surface in a beverage, a plurality of one or more target molecules are removed from the beverage and are bound to the modified surface.

A twenty-seventh continuing object of the invention is to provide an apparatus for insertion into a beverage, and whereby a stirring of the apparatus in the beverage for a period of time results in the binding (i.e., adherence) of a plurality of unwanted target molecules that are disposed in the beverage to the apparatus prior to consumption of the beverage.

A twenty-eighth continuing object of the invention is to provide a method and apparatus for extracting certain target molecules from a liquid and binding them to a modified activated polymer surface, wherein the modified polymer surface includes a plurality of molecularly imprinted polymer sites for retention of the target molecules, therein or a plurality of carbon nanotubes for retention of the target molecules, therein or a plurality of molecularly imprinted polymer sites and a plurality of carbon nanotubes for retention of the target molecules, therein.

A twenty-ninth continuing object of the invention is to provide a method and apparatus for extracting certain target molecules from a liquid and binding them to a modified activated polymer surface that includes chemically treating the surface of the polymer to bind a quantity of modified carbon nanotubes (MCN) particles, thereto, and thereby bind the target molecules to the MCN particles disposed proximate the surface of the polymer.

A thirtieth continuing object of the invention is to provide a method and apparatus for extracting certain target molecules from a liquid and binding them to a modified activated polymer surface that includes chemically treating the surface of the polymer to react chemically with and thereby bind the target molecules to the surface of the polymer and also chemically treating the surface of the polymer to bind a quantity of modified carbon nanotubes (MCN) segments, thereto, and thereby bind the target molecules to the modified carbon nanotubes disposed proximate the surface of the polymer.

A thirty-first continuing object of the invention is to provide a method and apparatus for extracting certain target molecules from a liquid and binding them to a modified activated polymer surface that is able to secure a quantity of modified carbon nanotubes (MCN) to the polymer surface at a plurality of different elevations above the surface, thereby increasing an effective density of the modified carbon nanotubes for a given surface area.

A thirty-second continuing object of the invention is to provide a method and apparatus for extracting certain target molecules from a liquid and binding them to a modified activated polymer surface that includes chemically treating the surface of the polymer to react chemically with and thereby bind the target molecules to the surface of the polymer and also chemically treating the surface of the polymer to bind a quantity of modified carbon nanotubes (MCN) segments, thereto, and thereby bind the target molecules to the modified carbon nanotubes disposed proximate the surface of the polymer, and also chemically treating the surface of the polymer to bind a quantity of molecularly imprinted polymer (MIPS) segments, thereto, and thereby bind the target molecules to the MIPS segments disposed proximate the surface of the polymer.

A thirty-third continuing object of the invention is to provide a method and apparatus for extracting certain target molecules from a liquid and binding them to a modified activated polymer surface that is able to secure a quantity of molecularly imprinted polymer (MIPS) segments to the polymer surface at a plurality of different elevations above the surface, thereby increasing an effective density of the MIPS segments for a given surface area and which is also able to secure a quantity of modified carbon nanotubes (MCN) to the polymer surface at a plurality of different elevations above the surface, thereby increasing the effective density of the MCN for the given surface area.

A thirty-fourth continuing object of the invention is to provide a method and apparatus for extracting certain target molecules from a liquid and binding them to a modified activated polymer surface that includes a decrease in the time required to remove a quantity of the target molecules or an increase in the number of target molecules that are removed by chemical modification of the polymer surface sufficient to facilitate chemical binding of the target molecules to the activated polymer surface or by the use of molecularly imprinted polymers (MIPS), or by the use of modified carbon nanotubes (MCN), or by a combination of all three in one consumer product.

A thirty-fifth continuing object of the invention is to provide a method and apparatus for extracting certain target molecules from a liquid and binding them to a modified activated polymer surface that includes a filter that can be inserted into a coffee brewing device.

A thirty-sixth continuing object of the invention is to provide a method and apparatus for extracting certain target molecules from a liquid and binding them to a modified activated polymer surface that includes a sheet, wherein one or both sides of the sheet are activated (i.e., treated) to bind one or more target molecules thereto by chemical binding or by the use of molecularly imprinted polymers or by the use of modified carbon nanotubes, or by any combination, thereof.

A thirty-seventh continuing object of the invention is to provide a method and apparatus for extracting certain target molecules from a liquid and binding them to a modified activated polymer surface that includes chemically treating the surface of the polymer to bind a quantity of modified carbon nanotubes (MCN), thereto, and thereby bind the target molecules to the MCN disposed proximate the surface of the polymer.

A thirty-eighth continuing object of the invention is to provide an apparatus for filtering a liquid.

Briefly, a method and apparatus for extracting target molecules from a liquid by binding them to an activated polymer surface that is constructed and used in accordance with the principles of the present invention has a polymer surface that has been chemically modified by a three or four step process to permit binding of the target molecules, thereto. After completion of the three step process certain target molecules or families of molecules can be chemically bound (i.e., secured) to a treated or activated polymer surface upon insertion of the chemically modified (i.e., treated) polymer surface into a water-based liquid that includes at least some of the target molecules. An optional additional step that is accomplished prior to insertion of the chemically modified polymer surface into the liquid includes binding (i.e., securing) of a plurality of fine molecularly imprinted polymer (MIPS) particles or modified carbon nanotubes (MCN), or both MIPS and MCN to the polymer surface to provide a further modified polymer surface. The further modified polymer surface may include (i.e., retain) a portion of the chemically modified polymer surface or, it can predominantly be coated with MIPS or with MCN, or any combination, thereof. The MIPS and MCN, in turn, are able to bind with greater specificity some, many, or all of the target molecules to the polymer surface. The MIPS and/or MCN that are bound (i.e., secured) to the modified or activated polymer surface may include receptor sites for any desired target molecule and, as desired, the MIPS and/or MCN that are bound (i.e., secured) to the modified polymer surface may include a plurality of different receptor sites for a plurality of different types of target molecules. Chemical structuring is optionally used to secure the MIPS and/or MCN at multiple elevations with respect to the chemically modified polymer surface, thereby increasing density of the MIPS and/or MCN as well as speed and efficacy in binding the target molecules to the MIPS and/or MCN. As preferred, the modified carbon nanotubes may be bound to the modified polymer surface instead of the MIPS or in addition to the MIPS to improve the efficacy of target molecule removal from the liquid.

### BRIEF DESCRIPTION OF THE DRAWINGS

FIG. 1 is a block-diagrammatic view of a method for producing an apparatus for extracting target molecules from a liquid and binding them to an activated polymer surface for removal from the liquid.

FIG. 2 is a view in perspective of an apparatus during use that includes a polymer surface which has been chemically modified (i.e., activated) according to the method of FIG. 1 to remove arsenic from the liquid.

FIG. 3 is a magnified view taken in cross-section of the apparatus of FIG. 2 that includes an activated polymer surface which has been chemically modified (i.e., treated) according to the method of FIG. 1 to optimally include a plurality of molecularly imprinted polymers (MIPS) and/or modified carbon nanotubes (MCN) disposed at various heights above the surface.

FIG. 4 is a view in perspective of a plurality of polymer sheets that include activated surfaces produced in accordance with the method of FIG. 1.

FIG. 5 is a view in perspective of a polymer filter constructed in accordance with the method of FIG. 1.

FIG. 6 is a view in perspective of a first modified stirring stick and a second modified stirring stick that have each been manufactured in accordance with the method of FIG. 1.

FIG. 7 is a view in perspective of a third modified stirring stick that has been manufactured in accordance with the method of FIG. 1.

### DETAILED DESCRIPTION OF THE INVENTION

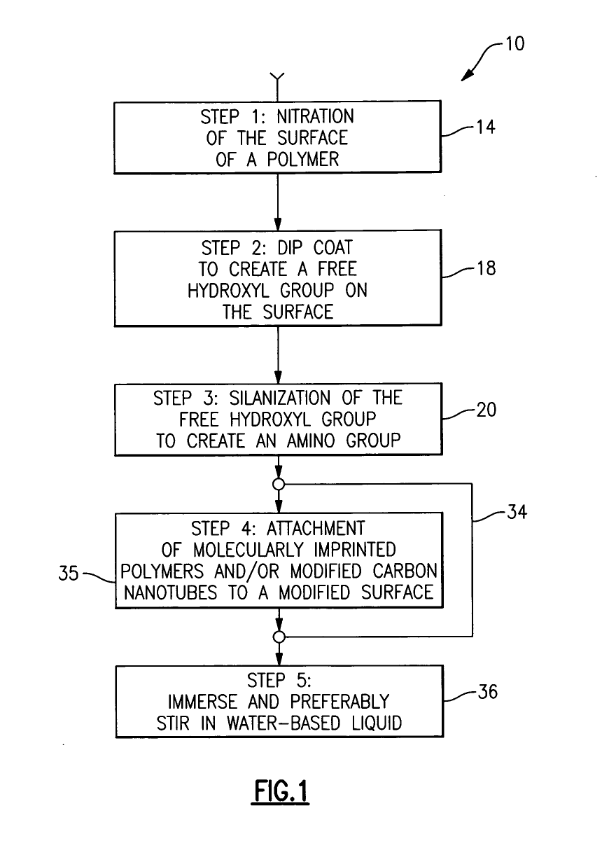

Referring on occasion to all of the FIGURE drawings and now, in particular to FIG. 1, is shown a method for producing an apparatus for extracting target molecules from a liquid and binding them to an activated polymer surface for removal from the liquid, identified in general, by the reference numeral 10.

The reader will notice that reference is occasionally made throughout the DETAILED DESCRIPTION OF THE INVENTION suggesting that the reader refer to a particular drawing FIGURE. The suggestion is at times made when the introduction of a new element requires the reader to refer to a different drawing FIGURE than the one currently being viewed and also when the timely viewing of another drawing FIGURE is believed to significantly improve ease of reading or enhance understanding. To promote rapid understanding of the instant invention the reader is encouraged to periodically refer to and review each of the drawing FIGURES for possible cross-referencing of component parts and for other potentially useful information.

Certain examples are shown in the above-identified FIGURES and are described in greater detail below. In describing these examples, like or identical reference numerals may be used to identify common or similar elements.

Briefly, the method 10 includes a multi-step treatment process to a plastic surface. For surface activation prior to MIPS attachment to, for example, a polycarbonate spoon 12, a three-step treatment process is described. After completion of the three-step process a “treated” or “modified” plastic surface is available for immersion into a water-based (i.e., aqueous) solution. Considerable variation is possible in accomplishing the third step depending on the type of target molecules that are to be extracted.

An additional and preferred fourth step is also described that binds Molecularly Imprinted Polymers (MIPS) 30 (and/or modified carbon nanotubes (MCN) 31) to the plastic surface before immersion. Additional variation to the third step is preferably accomplished prior to binding the MIPS 30 (and/or modified carbon nanotubes (MCN) 31) to the plastic surface so that the MIPS 30 (and/or modified carbon nanotubes (MCN) 31) are disposed at various heights above the plastic surface. After completion of the four-step process a “further treated” or “MIPS modified” plastic surface is available for immersion into the water-based (i.e., aqueous) solution.

A final fifth step is the immersion of the treated plastic surface or the further treated plastic surface into the water-based solution.

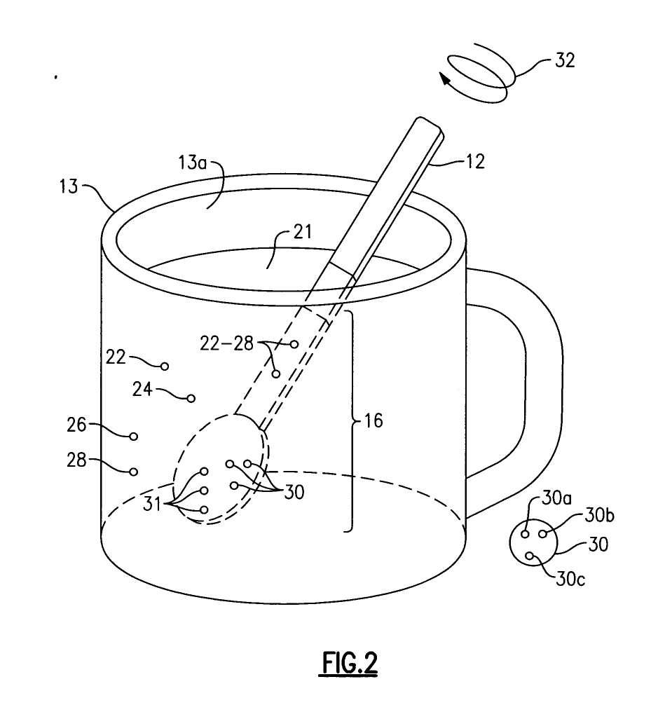

As described below, the polycarbonate spoon 12 (FIG. 2) is used. However, other types of plastic can be used with minor modifications to the method steps as would be knowable to those having ordinary skill in the art after having had benefit of the disclosure herein. It is understood that the plastic spoon 12 could, instead, be a plastic stirring stick or other type of plastic object. It is also understood that the method 10 could, instead, be applied to an interior surface 13a of a plastic container 13 as compared to an exterior surface of the spoon 12.

A first method step 14 includes nitration of a portion of the surface of the spoon 12. The portion is identified by bracket 16. If desired, the method 10 could be applied to all of the exterior surface of the spoon 12. However, as discoloration may occur it is generally preferred to treat only the portion 16.

An example of the first step 14 includes dipping the portion 16 of the spoon 12 into a solution of nitric acid and sulfuric acid. Considerable variation of the first step 14 is possible. Preferably, the portion 16 is disposed in the solution from 10 minutes up to about 2 hours. The solution could range from 0 sulfuric to 75% sulfuric acid while controlling the ratio of nitric and sulfuric acids. The temperature of the reaction can be from room temperature to 70° C.

The plastic surface is thereby nitrated at the benzene ring to form a nitrobenzene moiety. Some discoloration of the polymer does occur.

A second step 18 includes dipping the nitrated spoon 12 to create a free hydroxyl group on the surface. The portion 16 is dip coated into a solution of 10% ammonia solution and sodium hydroxide. This results in a loss of urea from the polymer and thereby generates a free hydroxyl group on the surface of the portion 16.

Some polymer is lost in this step, but it is superficial and does not appreciably affect the strength or appearance of the spoon 12. The spoon 12 remains physically and chemical stable after this step.

A third step 20 is used to produce, for example, amino groups on the surface of the portion 16 through silanization. There are numerous reagents available for this step and many methods are known, however ultimately a free amino group is bound to the surface of the spoon 12. The carbon backbone length of the silanizing reagent determines the space between the terminal amino group and the polymer surface and thus the separation from the surface which may have a resulting impact of binding efficiency.

After accomplishing the third step 20 the portion 16 becomes a “treated” or “modified” surface that is now able to bind a quantity of target molecules 22-28, thereto, after immersion into a water-based liquid 21 has occurred (see step five, described in greater detail, hereinafter).

To accomplish the third step 20, a 2% solution of a triethylsilyl-amino derivatizing reagent in ethanol with 2% dichloromethane was freshly made up before each modification. The solution was heated to 45° C. and the portion 16 of the spoon 12 was dipped into the solution with stirring for 30 minutes. The spoon 12 was removed and rinsed with ethanol before placing into an oven overnight set at 90° C. to bake. The step of baking is included as part of the third step 20.

After the baking step was completed, the spoon 12 was rinsed with methanol and air dried at room temperature. This completes the third step 20.

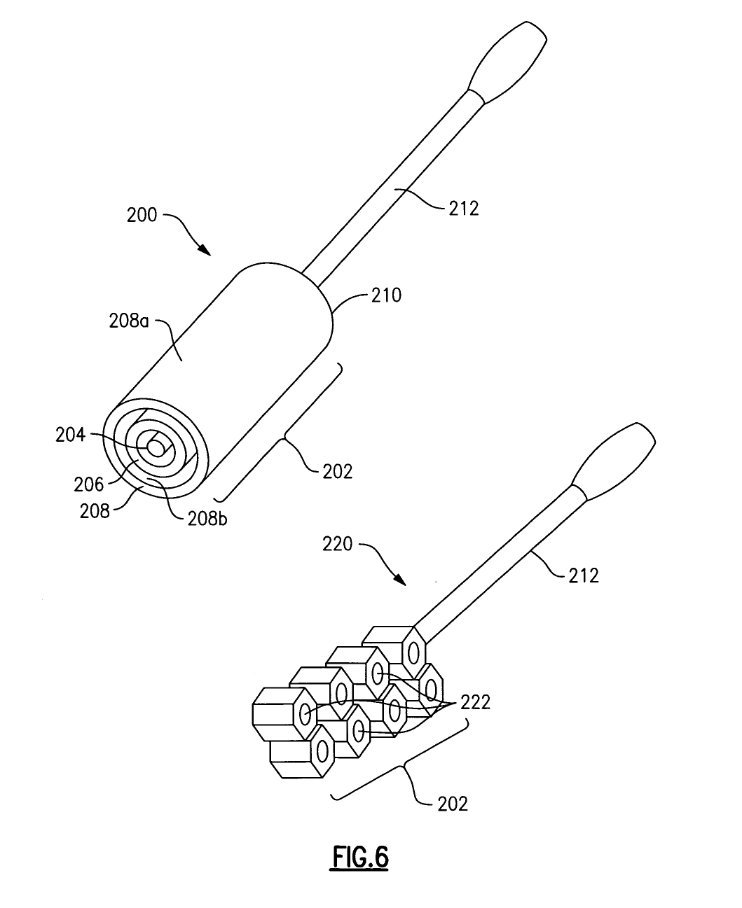

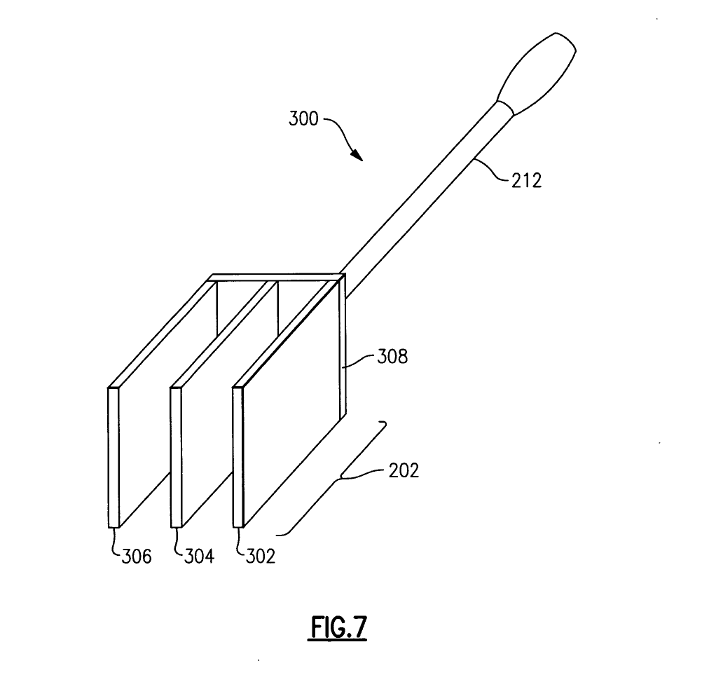

A discussion of the use and verification of efficacy of the apparatus produced by the method 10 follows: The water-based liquid 21 that was used for testing is water. The method for producing an apparatus for extracting target molecules from a liquid and binding them to a polymer surface for removal from the liquid 10 was used to prepare twenty spoons 12 and/or plastic stirring sticks (See FIGS. 6 and 7) which were then tested for their ability to bind arsenic in both its 3 and 5 form (as shown by reference numerals 22 and 24) to the surface at the portion 16 of the spoon 12 using a commercial colorimetric kit obtained from HACH®. The kit is sensitive down to 5-10 ppb and thus allowed removal and testing of arsenic 22, 24 below FDA/EPA limits for foodstuffs as well as municipal and bottled waters.

The procedure for testing involved reduction of the soluble arsenic 22, 24 to arsine gas which is then reacted with an arsine sensitive strip containing mercury which gives a semi-quantitative relationship between the intensity of the color formed and the amount of arsenic in solution. Tests consisted of a control and a treated sample in which the device (i.e., the spoon 12) had been stirred for varying amounts of time ranging from ten seconds to five minutes.

After several optimizations of all three steps 14, 18, 20 described resulted in the removal (i.e., binding to the spoon 12) of over 85% of the arsenic 3 and 5 (molecules 22 and 24) that was spiked into the liquid 21 within 20 seconds. In all cases levels were at or below the lowest levels sanctioned by the FDA/EPA.

Two different polycarbonate plastic spoons 12 were used for testing. Alternatively, clear polystyrene spoons could instead be used since both polymers have modifiable benzene rings on their structure.

Additional endosulfan molecule removal testing was accomplished, with initial endosulfan concentrations at 250 parts per billion (PPB). The spoon 12 was stirred, as shown by arrow 32, in liquid 21 for 20 seconds. The endosulfan concentration was reduced to 49 PPB, approximately an 80% reduction.

A fourth step 35 includes attachment of the MIPS 30 and/or modified carbon nanotubes (MCN) 31 to the spoon 12. Steps 1-3 (14, 18, 20) activated the polymer surfaces for enhanced specificity.

It is important to note that a great many chemistry variations are available for accomplishing the fourth step 35, that is the attachment of MIPS 30 or modified carbon nanotubes (MCN) 31 to the activated polymer spoon 12 (i.e. Step 3 20 activated surfaces). The fourth step 35 allows for an enhanced targeted specificity to the apparatus and allows for a very flexible process.

There are many means available to those skilled in the art to couple a carboxyl bearing MIPS 30 (and/or MCN 31) to the terminal reactive amino groups on the polymer surface.

A typical approach would be utilizing carbodiimide compounds which provide the most popular and versatile method for crosslinking to carboxylic acids. The most readily available and commonly used carbodiimides are the water-soluble EDC for aqueous crosslinking and the water-insoluble DCC for non-aqueous organic synthesis methods.

Carbodiimides, work by activating carboxyl groups for direct reaction with primary amines via amide bond formation. N-hydroxysuccinimide (NHS) or its water-soluble analog (sulfo-NHS) is often included in EDC coupling protocols to improve efficiency or create dry-stable (amine-reactive) intermediates. EDC couples NHS to carboxyls, forming an NHS ester that is considerably more stable than the O-acylisourea intermediate while allowing for efficient conjugation to primary amines.

After accomplishing the fourth step 35, it is possible to use the spoon 12 directly to remove target molecules 22, 24, 26, 28 from the liquid 21. See arrow 34 in FIG. 1.

Use of the spoon 12 is shown in a fifth step 36. The fifth step 36 includes immersing (at least) the portion 16 into the liquid 21 for a predetermined period of time, and preferably, stirring the spoon 12, as shown by arrow 32 in FIG. 2. There is no harm if the spoon 12 is immersed deeper than the portion 16 as the remaining, untreated (i.e., original) surface will not affect the liquid 21.

A quantity of the target molecules 22-28 are extracted from the liquid 21 and are bound to the treated (modified) surface of the spoon 12. After the period of time has elapsed, the spoon 12 can be removed from the liquid 21, thereby removing (i.e., extracting) a quantity of the target molecules 22-28 from the liquid 21. The liquid 21 is now ready for consumption (i.e., drinking or other use, such as for use in cooking).

If the spoon 12 is eliminated and the interior surface 13a of the container 13 is instead modified by the method 10 (minimally through step 3 and preferably through step 4), the liquid 21 would, instead, be added in the container 13 (i.e., a variation of step 5). Preferably, the container 13 could be closed and shaken. If desired, any object (including those not treated by the method 10) could be used to stir the liquid 21 in the container 13 as the interior surface 13a of the container 21 will have the ability to bind the target molecules 22-28, thereto.

A plurality of the nanometer-sized molecularly imprinted polymers (MIPS) 30 and/or MCN 31 are shown in FIG. 2 after binding to the activated polymer surface of the portion 16 of the spoon 12. The MIPS 30 and/or MCN 31 include receptor sites (30a, 30b, 30c; shown on enlarged separate MIP 30) for any desired target molecule 22-28 as well as receptor sites for other desired target molecules.

It is important to understand that the method 10, as disclosed herein, provides an effective way of attaching (i.e., binding) very small (nanometer-sized) MIPS 30 and/or MCN 31 to the activated polymer surface of the portion 16. This provides a substantial improvement in the use of MIPS 30 and MCN 31 because their extremely small size provides an orders of magnitude increase in the number of receptor sites for any given surface area or volume of the MIPS 30 and/or the MCN 31. This, therefore, solves a long-standing need to substantially improve the efficacy of MIPS 30 and/or MCN 31 in capturing target molecules 22-28. The substantially increased number of receptor sites increases the number (i.e., the quantity) of the target molecules 22-28 that can be removed from the liquid 21 in a given period of time.

Caffeine, as identified by reference numeral 26, is a preferred target molecule for the imprinting on the MIPS 30. Each of the MIPS 30 will then include a plurality of receptor sites on its surface for binding caffeine 26, thereto.

Additionally, an important and unexpected benefit is provided by use of the method 10 to bind MIPS 30 and/or MCN 31 to the surface of the spoon 12. Prior art usage of MIPS 30 has required maintaining a MIPS 30 size that is sufficiently large to allow placement of the MIPS 30 in a filter (not shown). The idea is that a beverage containing caffeine 26, such as coffee, would be allowed to flow through the filter. The filter would retain the MIPS 30 while allowing the beverage to pass into and out of the filter. This required a relatively large size for the MIPS 30, which for any given surface area or volume of the MIPS 30, severely limited the number of available binding sites, thereby resulting in a low extraction efficacy.

However, by way of comparison the instant method 10 is able to bind nanometer diameter MIPS 30 to the amino groups. These small MIPS 30 greatly increase the number of available caffeine 26 binding sites for any given surface area or volume of MIPS 30.

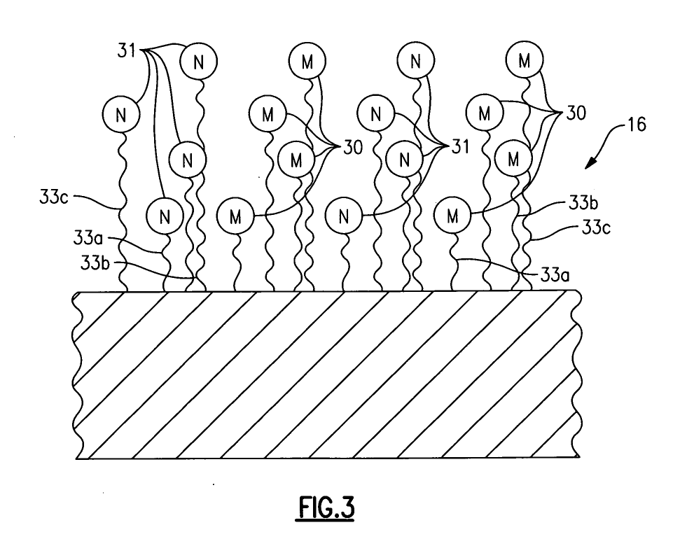

Referring now also to FIG. 3, the ability to bind MIPS 30 and/or MCN 31 at various elevations above the surface allows for a three-dimensional placement of the MIPS 30 and/or MCN 31 over (i.e., above) the surface of the [activated] portion 16 of the spoon 12. This, effectively, turns a two dimensional surface of the spoon 12 (i.e., the activated portion 16) into a three dimensional activated surface when viewed in cross-section with great magnification, as shown in FIG. 3.

As shown in FIG. 3, a plurality of MIPS 30 are bound to the polymer surface of the portion 16 at a first, lower elevation above the surface of the portion 16 by the use of a shorter length carbon backbone 33a. Similarly, a plurality of MCN 31 are bound to the polymer surface of the portion 16 at the first, lower elevation above the surface of the portion 16 by the use of the shorter length carbon backbone 33a.

Also shown, a further plurality of MIPS 30 are bound to the polymer surface of the portion 16 at a second, slightly higher elevation above the surface of the portion 16 by the use of a slightly longer length carbon backbone 33b. Similarly, a further plurality of MCN 31 are bound to the polymer surface of the portion 16 at the second, slightly higher elevation above the surface of the portion 16 by the use of the slightly longer length carbon backbone 33b.

Also shown, a still further plurality of MIPS 30 are bound to the polymer surface of the portion 16 at a third, even higher elevation above the surface of the portion 16 by the use of an even longer length carbon backbone 33c. Similarly, a further plurality of MCN 31 are bound to the polymer surface of the portion 16 at the third, even higher elevation above the surface of the portion 16 by the use of the even longer length carbon backbone 33c.

This novel use allows MIPS 30 and/or MCN 31 to be disposed where desired on a third vertical dimension thereby significantly further increasing the number of receptor sites for any given area of the surface of the portion 16.

As desired, any additional number of even shorter or even longer length carbon backbones (not shown) can be used to provide additional receptor sites packed into the same overall area of the surface of the portion 16, thereby further improving the rate of extraction and/or the quantity of target molecules 22-28 that are extracted in a given period of time.

Together, the small size of the MIPS 30 combined with three-dimensional stacking of the MIPS 30 on the surface of the spoon 12 significantly further increases the number of available caffeine 26 binding sites, when compared to any prior art solution.

This, in turn, allows for faster removal of any given quantity of the caffeine 26 target molecules from the liquid 21 and/or for a shorter time to remove a desired quantity or percentage of caffeine 26 molecules from the liquid 21, as compared to any prior art solution. This allows rapid use of the spoon 12 to effectively remove the desired target molecules 22-28.

It is to be understood that while the extraction of caffeine 26 is a preferred type of target molecule 22-28, that the method 10 and any type of apparatus (such as the spoon 12) produced by the method 10 can be modified to extract any desired target molecule 22-28, including those mentioned anywhere in this document and including those not mentioned specifically herein. This applies for any version, type or configuration of apparatus produced by the method 10 that is intended to remove one or more types of target molecules 22-28, simultaneously or individually.

The fourth step 35 is optionally accomplished prior to the fifth step 36 when greater specificity in extracting the target molecules 22-28 is required. This is because the MIPS 30 and/or MCN 31 are more selective in removing only the desired target molecules 22-28 from the liquid 21 than the resultant amino or thiol groups that result from accomplishing the third step 20 alone.

It is important to note that the entire portion 16 of the spoon 12 can include the amino groups for binding arsenic 22, 24 or endosulfan or other target molecules as desired. It is also possible to accomplish the fourth step 35 over the entire portion of the spoon 12 and to rely only on a plurality of MIPS 30 and/or a plurality of MCN 31 that include receptor sites for one or a variety of different target molecules 22-28, thereon.

It is also possible, after accomplishing the third step 20, to mask part of the portion 16 and to then accomplish the fourth step 35. The masking is then removed. This will result in some of the surface of the portion 16 including certain amino groups for binding certain of the target molecules 22-28 thereto, and a remainder of the surface of the portion 16 including MIPS 30 and/or MCN 31 for binding certain of the target molecules 22-28, thereto.

A remarkable version of the spoon 12 is produced that can, for example, simultaneously remove arsenic 3 and 5 (22, 24) and endosulfan using the exposed amino groups while also removing caffeine 26 (i.e., effectively decaffeinating the liquid 21) by use of the MIPS 30 and/or MCN 31, simultaneously.

In practical terms, a user of this type of spoon 12 simply immerses the (bottom) portion 16 in the liquid 21, stirs 32 the liquid 21, and then removes the spoon 12 while automatically removing significant quantities of toxins (arsenic 22, 24 and endosulfan) and decaffeinating the liquid 21, all occurring quickly and during the same activity.

In this manner there is no limit to the variety of different types of target molecules 22-28 that can simultaneously be removed quickly from the liquid 21.

After use the spoon 12 is discarded, as desired, because of its low cost. Alternately, the spoon 12 may be cleansed with an acidic solution and rinsed.

As desired, carboxylated carbon nanotubes may be attached to the surface of the spoon 12 in place of the MIPS 30 and/or MCN 31 or in addition to the MIPS 30 and/or MCN 31 for additional flexibility in removing the target molecules 22-28. The amino groups and/or MIPS 30 and/or MCN 31 can be modified to bind thiabenazole or virtually any other desired target molecule 22-28, thereto. Similarly, the amino groups and/or MIPS 30 and/or MCN 31 can be modified to bind another potentially toxic common agricultural pesticide, Malathion, thereto.

The target molecules 22-28 can include all manner of toxins, pesticides, insecticides, fungicides, carcinogens, and allergens, as desired.

It is to be understood that the spoon 12, or any desired device, that is constructed according to the teachings herein may be formed entirely of a plastic (i.e., a polymer) or, if preferred, a portion of the spoon 12 (that is able to be disposed in the liquid 21) may be formed of the plastic and a remaining portion of the spoon 12 may be formed of any desired substance other than the plastic, or if desired, of a different type of a plastic.

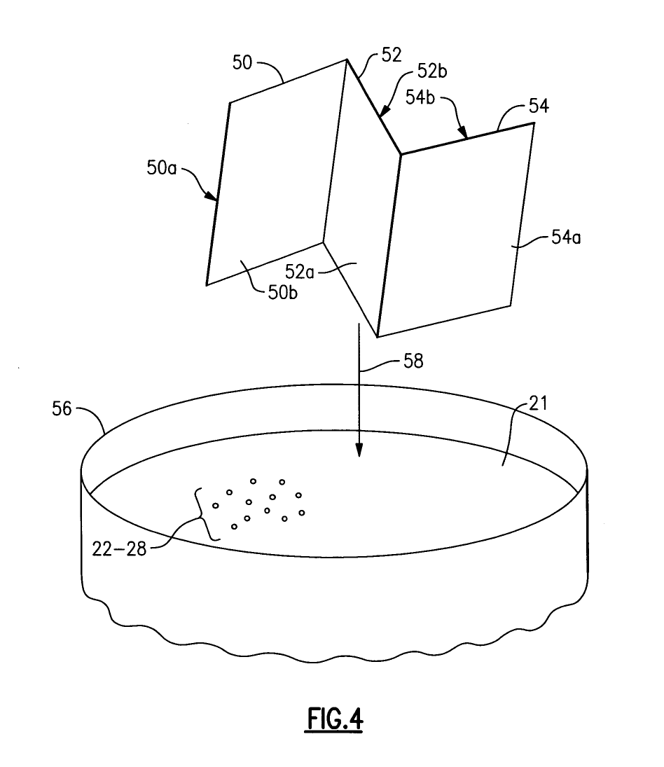

Referring now also to FIG. 4, is shown a plurality of polymer sheets 50, 52, 54 disposed above a barrel 56 (partially shown). The barrel 56 contains any desired type of the liquid 21. The sheets 50, 52, 54, as shown, are attached to one-another. If desired, any quantity of the sheets 50-54 can be attached together or, alternately, they could be separated for individual use.

Any desired version of the method 10 has been accomplished to the sheets 50-54 to provide the sheets 50-54 with activated surfaces 50a, 50b, 52a, 52b, 54a, 54b on opposite sides, thereof. Any combination of chemical binding, MIPS 30 and/or MCN 31 may be used to create the activated surfaces 50a, 50b, 52a, 52b, 54a, 54b. Masking after step three 20 has been completed, is also possible for any apparatus made by the method 10, as desired to maintain at least some area for chemical binding of the target molecules 22-28.

If desired, only one surface 50a, 50b, 52a, 52b, 54a, 54b on one side of each of the sheets 50-54 can be activated, however, it is generally preferred to activate all surfaces 50a, 50b, 52a, 52b, 54a, 54b to provide the greatest number of potential binding sites for the target molecules 22-28 that are disposed in the liquid 21.

As shown, the sheets 50-54 are arranged in an accordion style. Other configurations are possible as is the use of a single sheet or multiple detached sheets. To purify the liquid 21, a desired quantity of the sheets 50-54 is placed into the liquid 21, as shown by moving the sheets 50-54 in the direction of arrow 58. The liquid 21 may be stirred. After a predetermined period of time the sheets 50-54 are removed from the liquid 21.

The predetermined time is a variable based on the total activated surface 50a, 50b, 52a, 52b, 54a, 54b area of the sheets 50-54, the quantity of the liquid 21, and the quantity, variety and type of the target molecules 22-28 that are to be extracted from the liquid 21. The sheets 50-54 are used to bind and thereby extract a quantity of the desired target molecules 22-28 from the liquid 21.

In this manner, for example, a single sheet 50 could be placed in a thermos or small container of water (not shown) to treat the water prior to drinking. If desired, the sheet 50 could be discarded after use and a fresh sheet 52 used for the next desired purification. The sheets 50-54 could be included on a roll (not shown), similar to a roll of paper towels (not shown), where they are each separated from one-another by a row of perforations for removal one-at-a-time from the roll, as needed. If desired, individual sheets 50-54 could be stacked one atop the other for easy removal and use.

Alternately, the sheet 50 could be rinsed, as described herein, and prepared for reuse. The sheets 50-54, if intended for reuse, could be thicker or more durable. Under-developed countries, for example, could reuse the more durable sheets 50-54 to treat drinking water prior to consumption.

The sheets 50-54 can be activated by the method 10 to utilize chemical binding only, or to bind by the use of MIPS 30 and/or MCN 31, or for chemical binding and additionally by further activation of the polymer surface 50a, 50b, 52a, 52b, 54a, 54b to also include the use of MIPS 30 and/or MCN 31, as desired.

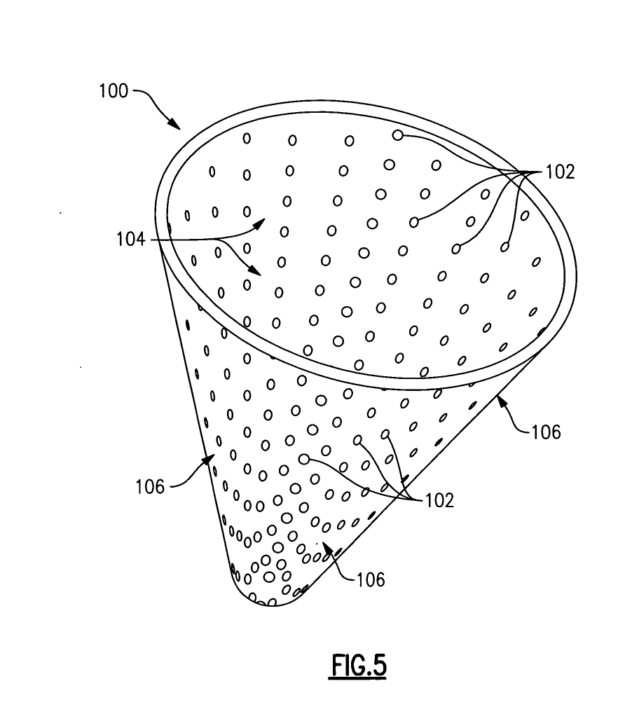

Referring now also to FIG. 5, is shown a view in perspective of a polymer filter, identified in general by the reference numeral, 100, that is constructed in accordance with the method 10.

The filter 100, as shown, includes a conical shape although any desired shaped is possible. A plurality of small perforations 102 are included through the sides of the filter 100. The perforations 102 permit water to pass there-through during use.

As desired, any portion of the filter 100 is treated according to any or all aspects of the method 10 to produce a sufficiently large activated surface. If desired, only an inside surface, as identified in general by the reference numeral 104, is treated by the method 10. If desired, the perforations 102 can also include activated surfaces as they pass through the sidewall of the cone-shaped filter 100. If desired, the entire filter 100, including the inside surface 104, the perforations 102, and an exterior surface, as identified in general by the reference numeral 106, are activated according to the method 10.

To decaffeinate a relatively small quantity of coffee, the filter 100 is placed inside of an automated home (or commercial) coffee maker. Ground coffee is added to an interior of the filter 100 and the coffee maker is allowed to cycle through its normal brewing cycle. Hot water flowing through the coffee grounds produces a caffeinated type of brewed coffee, assuming that a regular and not a caffeine-free type of ground coffee is being used.

However, the caffeinated coffee is subject to contact with the inside surface 104. This results in chemical binding of a portion of the coffee molecules (if the inside surface 104 has been chemically activated to bind with coffee molecules) and/or binding of the coffee molecules with the MIPS 30 (if MIPS 30 have been attached to the inside surface 104 by the method 10) and/or binding of the coffee molecules with the MCN 31 (if MCN 31 have been attached to the inside surface 104 by the method 10), thereby decaffeinating the brewed coffee.

The brewed coffee must flow through the perforations 102 in order to exit. If the perforations 102 are also activated (in any of the above-described ways as the inside surface 104 may be activated), additional binding of the coffee molecules will occur, thereby extracting an additional quantity of caffeine 26 molecules and further decaffeinating the brewed coffee. The brewed coffee, as it exits the perforations 102, has been purified and will be sufficiently decaffeinated. If the exterior surface 106 is also activated, then additional decaffeination will occur which further improves efficacy.

It is important to note that the use of MIPS 30 and/or MCN 31 provides an especially high degree of specificity. This provides an especially fine tasting decaffeinated coffee because it avoids the removal of large quantities of other aromatic molecules that contribute to and influence the more subtle nuances of fragrance and character inherent in fine coffees. Accordingly, chemical binding may well be omitted with reliance on MIPS 30 and/or MCN 31 to produce the filter 100.

If the coffee maker uses prior art replaceable paper filter cones, the filter 100 can be used to replace the prior art paper cones. If desired, one of the paper cones can be placed in the filter 100 and used as a liner before adding the ground coffee.

Prior-art plastic single-cup coffee brewing devices (not shown) are available that are placed atop a coffee cup or coffee mug prior to brewing a cup of coffee. A prior art paper cone is placed therein and ground coffee is placed in the prior art paper cone. Hot water is added and brewed coffee flows through the paper, through holes provided at the bottom of the coffee brewing device, and into the cup or mug. If desired, the method 10 can be applied to activate the inside surface of the coffee brewing device and, preferably, the holes at the bottom of the coffee brewing device, thereby producing decaffeinated coffee, one cup at a time from any preferred blend of caffeinated coffee.

Any version of the filter 100 can be activated by use of the method 10 to provide chemical binding only, or binding by the use of MIPS 30 and/or MCN 31, or chemical binding and additionally by further activation of the polymer inside and exterior surfaces 104, 106 and the perforations 102 to also include the use of MIPS 30 and/or MCN 31.

Testing of the method 10 has demonstrated an ability to extract arsenic 3, arsenic 5 (molecules 22, 24) and endosulfan with spoons 12 modified to the third step 20. Given the ability of the disclosed method 10 to additionally attach MIPS 30 and or MCN 31 to the spoon 12 it is predicted that the spoon 12 would then have a significantly enhanced ability to bind a very wide range of targets with much improved specificity and efficacy. These would include a wide range of toxic metals and generally undesirable components in foods and beverages. Work with MIPS 30 and MCN 31 has shown that they have the ability to decaffeinate a beverage such as coffee.

Various means have been disclosed herein for increasing the number of binding sites. For example, both activated surfaces 50a and 50b, 52a and 52b, 54a and 54b of each of the sheets 50, 52, 54 can be activated to increase the overall number of available binding sites. Similarly, both the interior surface 104 and the exterior surface 106 of the filter 100 can be activated to increase the overall number of available binding sites. Even the interior of the perforations 102 can be activated to further increase the overall number of available binding sites. The greater the number of binding sites that the liquid 21 is allowed to contact for a given period of time will result in a greater quantity of the target molecules 22-28 binding with and thereby being extracted from the liquid 21. This in turn, decreases the number of target molecules 22-28 remaining in the liquid 21 after use of any device that includes treatment of a polymer surface according to any aspect of the method 10. FIG. 3 teaches yet another way to increase the number of available binding sites by disposing a plurality of the MIPS 30 and/or the MCN 31 at various elevations above the polymer surface. All of these are various means for increasing the number of available binding sites to extract the target molecules 22-28.

Referring now also to FIG. 6, is shown a first modified stirring stick, identified in general by the reference numeral 200. The first modified stirring stick 200 includes a polymer that has been treated according to the method 10 to include an activated portion, as shown by bracket 202. The portion 202 is said to be activated because it is now able to bind any desired type or range of the target molecules 22-28, thereto, by use of chemical binding (after the third step 20), and/or by MIPS 30 (after the fourth 35) and/or by MCN 31 (after the fourth step 35). Any one, two or all three binding methods are possible for inclusion in the activated portion 202 with any particular version of the first modified stirring stick 200 (or any other apparatus/device that is produced (i.e., manufactured) by the method 10).

The activated portion 202 includes concentric cylinders 204, 206, and 208. The concentric cylinders 204-208 are jointed at an upper end 210 of the cylinders 204-208. A bottom of a handle 212 is attached to the upper end 210. A remaining portion of the handle 212 extends upward away from the cylinders 204-208. During use, the handle 212 is grasped and the activated portion 202 is inserted into any desired type of the liquid 21.

Preferably, the handle 212 is used to stir (i.e., is rotated) the first modified stirring stick 200 in the liquid 21 for a predetermined period of time. The predetermined period of time includes a range of times that can vary for each particular application, depending on the type of the liquid 21, the temperature of the liquid 21, the type or range of the target molecules 22-28 that are to be extracted from the liquid 21, and the desired degree of extraction (i.e., the number or percentage of target molecules 22-28 that are to be removed from the liquid 21).

The range can typically vary from a few seconds to a few minutes with most applications requiring from about 10 to 30 seconds of immersion and stirring time to achieve a preferred rate of target molecule 22-28 extraction from the liquid 21.

The handle 212 is then used to lift the modified stirring stick 200 out of the liquid 21. A purified version of the liquid 21 is then provided by use of the modified stirring stick 200 (or by use of any apparatus that is formed by the method 10) for consumption.

Each of the cylinders 204-208 includes an outer surface and an inner surface. The outer surface is illustrated on the largest diameter cylinder 208 by the reference numeral 208a. The inner surface is illustrated on the largest diameter cylinder 208 by the reference numeral 208b.

A small gap is provided between the outer surface of the innermost cylinder 204 and the inner surface of the next larger cylinder 206. The gap is similarly provided between the outer surface of the next larger cylinder 206 and the inner surface 208b of the largest diameter cylinder 208. The gaps allow for the liquid 21 to enter and contact the inner and outer surfaces 208b, 208a of all of the cylinders 204-208 when the activated portion 202 is immersed in the liquid 21.

The inner and outer surfaces 208b, 208a of all of the cylinders 204-208 have, preferably, been treated (or coated) by the method 10 to include the activated portion 202. The use of the concentric cylinders 204-208 with inner and outer surfaces 208b, 208a that include the activated portion 202 is shown because it provides one possible way of increasing a surface area of the activated portion 202. A greater surface area of the activated portion 202 is desired because it decreases the time required to extract a quantity of the target molecules 22-28 and/or increases the number of the target molecules 22-28 that are extracted in any given period of time.

There are innumerable ways of increasing the surface area of the activated portion 202. A second modified stirring stick, identified in general by the reference numeral 220 is also shown in FIG. 6. The second modified stirring stick 220 includes a plurality of side-by-side hollow honeycomb sections 222 that are attached to one-another. The bottom of the handle 212 is attached to an end of the honeycomb sections 222, where desired. Use of the method 10 to treat the inside and outside surfaces of the honeycomb sections 222 provides another way to increase the overall surface area of the activated portion 202.

Accordingly, the first and second modified stirring sticks 200, 220 provide means for increasing the surface area of the activated portions 202, thereof.

Accordingly, it is possible to provide any desired shape for any polymer device that is produced according to the method 10. For example, it is possible to manufacture “honeycomb” shaped polymer sections that include activated areas which can be placed in barrels or other containers of water (as the liquid 21) and used to purify the water before drinking, similar to the sheets 50, 52, 54.

It is equally possible to produce a length of a polymer-based “string” where the exterior surface is treated to include the activated area along its entire longitudinal length.

Similarly, the amount of activated area that is required can be easily calculated for many applications based on the volume (i.e., number of gallons) of the liquid 21 to be treated (i.e., purified). For example, if it has been shown that one sheet 50 is required to treat a 10 gallon container of water (as the liquid 21), then three sheets 50, 52, 54 would be required to treat a 30 gallon barrel of water. The same principle applies when determining the number of feet of “activated” string that is required. This helps facilitate use of any device manufactured according to the method 10.

Referring now also to FIG. 7, is shown a third modified stirring stick, identified in general by the reference numeral 300. The third modified stirring stick 300 includes a first polymer plate 302, a second polymer plate 304, and a third polymer plate 306 that are all disposed in a parallel spaced-apart planar orientation with respect to one-another. The three plates 302, 304, 306 are each attached at an upper end to a perpendicular polymer mounting plate 308. The handle 212 is attached to an opposite side of the mounting plate 308. Preferably, all sides of all three plates 302, 304, 306 and the mounting plate 308 have all been treated (or coated) in accordance with the method 10 to include the activated portion 202.

This illustrates another possible way to increase surface area of the activated portion 202. It also illustrates another important advantage offered by the instant invention, and that is one preferred way to manufacture a device that can be tailored to target any desired range of different molecules.

For example, it is possible to manufacture a very large quantity of the first plates 302 that have been treated up through the third step 20 and which include chemical binding sites for a particular molecule, let us assume arsenic 22, 24. The first plate 302 has not yet been attached to the third modified stirring stick 300. As such, the first plate 302 is available for use with any embodiment of the invention.

Let us assume that a large quantity of the second plate 304 has been manufactured in accordance with the method 10 to include MIPS 30 with receptor sites for caffeine 26.

Let us assume that a large quantity of the third plate 306 has been manufactured in accordance with the method 10 to include MCN 31 with receptor sites for endosulfan. Let us assume also, that a large quantity of the mounting plate 308 has not been treated. And let us assume that other large quantities of the mounting plate 308 has been manufactured in accordance with the method 10 to include MIPS 30 or MCN 31 or both MIPS 30 and MCN 31 or chemical binding sites, either alone or in combination with MIPS 30 and/or MCN 30 to target any other desired molecule 22-28.

Let us also assume that numerous other versions of the first, second and third plates 302, 304, 306 have been manufactured using any or all of the disclosed methods for binding (i.e., chemical, MIPS 30, MCN 31) targeting any desired molecule 22-28 or even any desired trace element that includes a unique and predicable geometric shape.

In this fashion, it is possible to pick and choose which of the first, second and third plates 302, 304, 306 and which version of the mounting plate 308 is to be used during assembly of the third modified stirring stick 300. Ultrasonic welding, thermal welding, or adhesives can be used to secure the various plates 302, 304, 306, 308 together and to attach the handle 212. Alternately, these parts could be designed to snap together or the various plates 302, 304, 306, 308 could each include a first half of a dovetail groove that is designed to fit into a corresponding second half of a dovetail groove that is provided in the mounting plate 308.

In this manner, the third modified stirring stick 300 can be tailored to the particular needs of any group of individuals or larger community. For example, it may be noted that arsenic and endosulfan are prevalent in the drinking water in one area while endosulfan and thiabendazole are prevalent elsewhere. Any version of the third modified stirring stick 300 can be manufactured to remove whatever range of toxicants or other unwanted molecules 22-28 may be present.

Receptor sites for caffeine 26 would be included in a version of the third modified stirring stick 300 only when it is desirable to also simultaneously decaffeinate the liquid 21.

It is of course possible to include as many other additional plates (not shown) as desired, as there is no limit to the number of plates 302, 304, 306 that can be used with any version of the third modified stirring stick 300, other than maintaining a usable or practical overall size.

In this manner, one drink at a time, it is possible to use a preferred version of the third modified stirring stick 300, immerse it in the liquid 21 for about 20 or so seconds while stirring, remove the third modified stirring stick 300, and consume a now purified form of the liquid 21 that includes substantially reduced amounts of the targeted molecules 22-28.

As desired, the third modified stirring sticks 300 may be discarded or reused, after preparation as previously described.

It is important to note that any version of device (apparatus) manufactured according to the method 10 can be tailored, similar to that as described above, to extract any particular target molecule 22-28 or range of target molecules 22-28. It is also possible to mask off certain portions of any device during treatment and in this way to manipulate which portions of the device include chemical binding and/or binding by the use of MIPS 30 and/or MCN 31.

It is also important to summarize by noting that virtually any shape is possible for any polymer-based device that is manufactured in accordance with the method 10.

As briefly mentioned above, the method 10 can also be used to extract toxic trace elements using MIPS 30 and/or MCN 31 providing they include a recurring unique geometric shape.

It is also important to note that the method 10 is useful in producing devices that are effective over an extremely wide range of concentrations of the target molecules 22-28. Many of the toxicants, for example, are measured in PPB whereas caffeine 26 concentrations are measured in milligrams. Devices produced using the variations of the method 10 described, herein, are suitable for these and other diverse extraction requirements.

Other changes are also possible for the method 10 and for any device produced by the method 10. For example, the filter 100 can also be further modified according to the method 10 to include a different size and shape for use in different types of equipment to extract any conceivable type or range of target molecules 22-28, other than or in addition to caffeine 26.

Any device produced by the method 10 can be tailored to extract whatever molecules are desired. Examples of toxic metals and/or metalloids (partial list) include arsenic, antimony, barium, beryllium, cadmium, lead, mercury, osmium, thallium, vanadium and any radioactive metal. Aluminum and other metals can also be targeted for extraction, if desired. Examples of trace elements (partial list) include chromium, nickel, copper, zinc and iron. Selenium and tellurium can also be targeted for extraction, if desired.

It is especially important to note that the method 10 and any version of the apparatus produced by the method 10, when used, does not introduce any new chemicals, compounds or substances into the liquid 21. During use, the apparatus is inserted into the liquid 21, preferably stirred, and then removed after a period of time, thereby extracting a quantity of whatever molecules 22-28 have been targeted for removal from the liquid 21. Unlike all known relevant (i.e., similar) prior art solutions, the method 10 and any apparatus produced by the method 10 does not leave behind a residue or introduce anything new into the liquid 21. It only extracts those molecules 22-28 that have been targeted for removal by application of the method 10.

The invention has been shown, described, and illustrated in substantial detail with reference to the presently preferred embodiment. It will be understood by those skilled in this art that other and further changes and modifications may be made without departing from the spirit and scope of the invention which is defined by the claims appended hereto.

What is claimed is:

1. A method for treating a surface of a polymer, comprising the steps of:
chemically treating at least a portion of the surface of the polymer sufficient to provide an activated polymer surface, wherein said activated polymer surface is able to bind one or more target molecules that are disposed in a water-based liquid to said activated polymer surface during a step of placing said activated polymer surface in contact with said water-based liquid for a predetermined period of time.

2. The method of claim 1 wherein the step of placing said activated polymer surface in contact with said water-based liquid includes the step of inserting said activated polymer surface into said water-based liquid for said predetermined period of time.

3. The method of claim 2 including the additional step of stirring said water-based liquid for said predetermined period of time after the step of inserting said activated polymer surface into said water-based liquid.

4. The method of claim 1 wherein the method for treating a surface of polymer includes the step of treating a portion of a surface of a spoon, stirring stick or other shaped object that is formed of a polymer or which includes a polymer attached, thereto.

5. The method of claim 1 wherein the method for treating a surface of polymer includes the step of treating at least a portion of a surface of an interior of a container, wherein said interior of said container includes a polymer.

6. The method of claim 1 including the additional step of further modifying said activated polymer surface to produce a further activated polymer surface that includes a plurality of molecularly imprinted polymers that are attached to or proximate the further activated polymer surface or further modifying said activated polymer surface to produce a further activated polymer surface that includes a plurality of modified carbon nanotubes that are attached to or proximate said further activated polymer surface prior to the step of placing said activated polymer surface in contact with said water-based liquid for a predetermined period of time.

7. An apparatus that is produced by the method of claim 1.

8. An apparatus for exposure to said water-based liquid, wherein said apparatus includes at least a portion of a polymer surface that has been treated to provide an activated surface that is able to bind a desired target molecule or a desired range of target molecules to said activated surface subsequent to an immersion of said activated surface into said water-based liquid.

9. The apparatus of claim 8 wherein said apparatus includes a plastic spoon, a plastic stirring stick, or other type of plastic object.

10. The apparatus of claim 8 wherein said apparatus includes a plastic container, and wherein said portion of a polymer surface that has been treated includes an interior of said container.

11. The apparatus of claim 8 wherein said apparatus includes a polymer sheet.

12. The apparatus of claim 8 wherein said apparatus includes a filter.

13. The apparatus of claim 12 wherein said activated surface includes an inside surface of said filter.

14. The apparatus of claim 12 wherein said filter includes a plurality of perforations that pass through a sidewall of said filter, and wherein said activated surface includes an inside surface of at least some of said perforations.

15. The apparatus of claim 13 wherein said filter is able to be inserted into a coffee maker or placed atop a container, and wherein said target molecule includes caffeine.

16. A device for placement in a liquid to reduce a number of target molecules in said liquid, comprising:
(a) a quantity of a plastic included with said device; and
(b) at least one molecularly imprinted polymer that is attached to said plastic, wherein said molecularly imprinted polymer includes at least one receptor site that is able to retain at least one of said target molecules for removal from said liquid when said device is immersed in said liquid or at least one modified carbon nanotube that is attached to said plastic, wherein said modified carbon nanotube includes at least one receptor site that is able to retain at least one of said target molecules for removal from said liquid when said device is immersed in said liquid.

17. The device of claim 16 wherein said target molecules include caffeine.

18. The device of claim 16 wherein said target molecules are selected from the group consisting of a toxin, toxicant, pesticide, insecticide, fungicide, carcinogen, allergen, toxic metal, and pollutant.

19. The device of claim 16 wherein said target molecules include a plurality of different types of molecules.

20. The device of claim 16 wherein said device is formed entirely of said plastic.

21. The device of claim 16 wherein said device is formed partially of said plastic and partially of another substance.

22. The device of claim 16 wherein said at least one molecularly imprinted polymer that is attached to said plastic includes a plurality of molecularly imprinted polymers, and wherein said plurality of molecularly imprinted polymers are chemically bound to a surface of said plastic or wherein said at least one modified carbon nanotube that is attached to said plastic includes a plurality of modified carbon nanotubes, and wherein said plurality of modified carbon nanotubes are chemically bound to said surface of said plastic.

23. The device of claim 22 wherein at least one of said plurality of molecularly imprinted polymers is disposed at a first elevation above said surface, and wherein at least a remaining one of said plurality of molecularly imprinted polymers is disposed at a second elevation above said surface, and wherein said first elevation is different than said second elevation.

24. The device of claim 22 wherein at least one of said plurality of modified carbon nanotubes is disposed at a first elevation above said surface, and wherein at least a remaining one of said plurality of modified carbon nanotubes is disposed at a second elevation above said surface, and wherein said first elevation is different than said second elevation.

25. A device for placement in a liquid to reduce a quantity of a substance in said liquid, comprising:
(a) a quantity of a plastic included with said device; and
(b) at least one imprinted polymer or one modified carbon nanotube attached to said plastic, wherein said imprinted polymer or said modified carbon nanotube includes at least one receptor site that is able to retain at least some of said substance for removal from said liquid when said device is immersed in said liquid.

26. The device of claim 25 wherein said substance is selected from the group consisting of a toxin, toxicant, pesticide, insecticide, fungicide, carcinogen, allergen, toxic metal, and pollutant.

27. The apparatus of claim 8 wherein said activated surface includes chemical binding of said desired target molecule or said desired range of target molecules to said activated surface, or at least two molecularly imprinted polymers attached proximate said activated surface for binding of said desired target molecule or said desired range of target molecules to said activated surface, or at least two modified carbon nanotubes attached proximate said surface for binding of said desired target molecule or said desired range of target molecules to said activated surface.

28. The apparatus of claim 27 including means for increasing a quantity of binding sites on said apparatus.

29. The apparatus of claim 28 wherein said means for increasing a quantity of binding sites includes increasing a surface area of said portion of said polymer surface that has been treated to provide said activated surface.

30. The apparatus of claim 28 wherein said means for increasing a quantity of binding sites includes binding at least one of said at least two molecularly imprinted polymers at a first elevation above said surface, and binding at least a remaining one of said at least two molecularly imprinted polymers at a second elevation above said surface, wherein said first elevation is different than said second elevation.

31. The apparatus of claim 28 wherein said means for increasing a quantity of binding sites includes binding at least one of said at least two modified carbon nanotubes at a first elevation above said surface, and binding at least a remaining one of said at least two modified carbon nanotubes at a second elevation above said surface, wherein said first elevation is different than said second elevation.

32. The apparatus of claim 30 wherein said at least one of said at least two molecularly imprinted polymers is attached to a first carbon backbone at an upper end of said first carbon backbone, and wherein an opposite end of said first carbon backbone is attached to said polymer surface, and wherein said first carbon backbone includes a first backbone length and wherein said remaining one of said at least two molecularly imprinted polymers is attached to a second carbon backbone at an upper end of said second carbon backbone, and wherein an opposite end of said second carbon backbone is attached to said polymer surface, and wherein said second carbon backbone includes a second backbone length, and wherein said first backbone length is different than said second backbone length.

33. An improvement to a device for filtering a liquid, wherein the improvement comprises:
chemically treating a polymer surface sufficient to change said polymer surface from an inert surface that is not capable of binding a substance thereto into an activated polymer surface that is capable of binding a quantity of molecules of said substance, thereto, when said activated polymer surface is disposed in the liquid, and wherein the liquid additionally includes a purée, mash, milk, or soup.

34. The improvement of claim 33 wherein the improvement additionally comprises:
attaching a plurality of molecularly imprinted polymers to said activated polymer surface or attaching a plurality of modified carbon nanotubes to said activated polymer surface or attaching said plurality of molecularly imprinted polymers and said plurality of modified carbon nanotubes to said activated polymer surface to increase an efficacy of said binding of said quantity of molecules of said substance, thereto.

35. An improvement to a device for filtering a liquid, wherein the improvement comprises:
chemically treating a polymer surface sufficient to change said polymer surface from an inert surface that is not capable of binding a substance thereto into an activated polymer surface that is capable of simultaneously binding a plurality of molecules of a plurality of different substances, thereto, when said activated polymer surface is disposed in the liquid, and wherein the liquid additionally includes a purée, mash, milk, or soup.

36. The improvement of claim 35 wherein the improvement additionally comprises:
attaching a plurality of molecularly imprinted polymers to said activated polymer surface or attaching a plurality of modified carbon nanotubes to said activated polymer surface or attaching said plurality of molecularly imprinted polymers and said plurality of modified carbon nanotubes to said activated polymer surface to increase an efficacy of said binding of said plurality of molecules of said plurality of different substances, thereto.
